(19) United States
(12) Patent Application Publication
(10) Pub. No.: US 2015/0301713 A1
(43) Pub. Date: Oct. 22, 2015

(54) PORTABLE DEVICE

(71) Applicant: SHARP KABUSHIKI KAISHA, Osaka-shi, Osaka (JP)

(72) Inventor: Junichi SUDA, Osaka-shi (JP)

(21) Appl. No.: 14/440,636

(22) PCT Filed: Feb. 21, 2014
(86) PCT No.: PCT/JP2014/054166

§ 371 Date: May 5, 2015

(30) Foreign Application Priority Data
Mar. 11, 2013 (JP) 2013-048258

(51) Int. Cl. G06F 3/0487; G06F 3/0484; H04M 1/02

(52) U.S. Cl. CPC G06F 3/0487; H04M 1/0281; G06F 3/04842

(57) ABSTRACT

In order to prevent an operational error without causing any trouble to receipt of an input operation, a portable device (1) includes: a menu display section (122) for displaying a menu; a portable device holding hand determination section (125) for determining a portable device holding hand, the portable device holding hand being a hand with which the portable device (1) is held; and an invalid region setting section (126) for, when the menu is displayed, setting, as an invalid region, a region in which the menu is not displayed and which corresponds to a result of the determination of the portable device holding hand.

### TECHNICAL FIELD

The present invention relates to prevention of occurrence of an operational error in a portable device which receives an input with respect to a display surface thereof.

### BACKGROUND ART

There has been conventionally developed a technique for improvement in operability of a portable device such as a smartphone provided with a touch panel. For example, according to Patent Literature 1, which part of a mobile phone is held is detected with use of a touch sensor that is provided so as to surround sides of a touch screen, and a place in accordance with a result of the detection is set as an invalidated region in which a touch operation is invalidated, so that a finger can be placed at rest in the invalidated region. Meanwhile, Patent Literature 2 discloses a technique for changing a display position of a user interface (UI) in accordance with a direction in which a trajectory of a scroll operation protrudes.

### CITATION LIST

Patent Literature 1

Japanese Patent Application Publication

Tokukai, No. 2011-28603 (Publication Date: Feb. 10, 2011)

Patent Literature 2

Japanese Patent Application Publication

Tokukai, No. 2012-155675 (Publication Date: Aug. 16, 2012)

### SUMMARY OF INVENTION

### Technical Problem

Note here that a portable device such as a smartphone for receiving an input operation with respect to a display surface thereof may be operated with a hand that is holding the portable device. During such an operation, there is a problem of occurrence of an operational error which is not intended by a user. For example, in a case where the portable device is operated with a thumb of a right hand while being held with the right hand, an operational error occurs in the portable device when a root portion of the thumb of the right hand touches a screen. It seems possible to prevent the operational error by setting a vicinity of a position of a portable device holding hand of the user as an invalid region in which an input operation is invalidated. However, the technique, disclosed in Patent Literature 1, for setting the invalid region, has a problem of not considering a timing at which to set the invalid region. That is, according to Patent Literature 1, since a vicinity of a position of a mobile phone holding hand is set as the invalidated region at all times, it is impossible to receive an input operation by utilizing an entire display surface. The present invention has been made in view of the problems, and an object of the present invention is to provide, for example, a portable device capable of, without causing any trouble to receipt of an input operation, preventing an operational error by invalidating, at a timing at which an input operation should be invalidated (e.g. a timing at which the operational error may occur in the portable device), the input operation with respect to a region in which the operational error may occur in the portable device.

### Solution to Problem

In order to attain the object, a portable device according to one aspect of the present invention is a portable device for receiving an input operation with respect to a display surface thereof on which to display an image, the portable device including: a display section for, in accordance with a given input operation, displaying, in a partial region of the display surface, an input target object which serves as a target of the input operation; a portable device holding hand determination section for determining which of a right hand and a left hand is a portable device holding hand; and an invalid region setting section for, while the input target object is being displayed, invalidating the input operation with respect to a region in which no input target object is displayed and which corresponds to a result of the determination by the portable device holding hand determination section.

Further, a portable device according to another aspect of the present invention is a portable device for receiving an input operation with respect to a display surface thereof on which to display an image, the portable device including: a portable device holding hand determination section for determining, from a trajectory of a drag operation starting from an edge of the display surface, which of a right hand and a left hand is a portable device holding hand; and an invalid region setting section for, when the portable device holding hand determination section determines the portable device holding hand, invalidating the input operation with respect to a region of the display surface which region corresponds to a result of the determination of the portable device holding hand.

### Advantageous Effects of Invention

According to the above aspects of the present invention, an input operation with respect to a region in which an operational error may occur is invalidated at a timing at which the input operation should be invalidated (a timing at which an input target object is displayed, a timing at which a drag operation starting from an edge of a display surface is carried out, or the like). This yields an effect of preventing an operational error without causing any trouble to receipt of an input operation.

### BRIEF DESCRIPTION OF DRAWINGS

FIG. 1 is a block diagram illustrating a substantial part of a configuration of a portable device according to Embodiment 1 of the present invention.

FIG. 2 is a diagram illustrating an example of display of a menu.

FIG. 3 is a diagram illustrating a region in which an operational error easily occurs.

FIG. 4 is a diagram illustrating an example of setting of an invalid region.

FIG. 5 is a diagram illustrating another example of setting of an invalid region.

FIG. 6 is a diagram illustrating a trajectory of a menu display operation.

FIG. 7 is a flowchart showing an example of an invalid region setting process.

FIG. 8 is a flowchart showing an example of an invalid region setting process carried out in a case where a portable device holding hand is determined in accordance with a touched region detected outside a region, in which a menu is displayed, during an operation with respect to the menu.

FIG. 9 is a diagram illustrating how a portable device inclines in accordance with a portable device holding hand.

FIG. 10 is a flowchart showing an example of an invalid region setting process carried out in a case where a portable device holding hand is determined in accordance with an inclination of a portable device.

FIG. 11 is a diagram illustrating a trajectory of a vertical drag operation.

FIG. 12 is a flowchart showing an example of an invalid region setting process carried out in a case where a portable device holding hand is determined in accordance with analysis of a trajectory of a drag operation.

FIG. 13 is a flowchart showing an example of an invalid region resetting process.

### DESCRIPTION OF EMBODIMENTS

### Embodiment 1

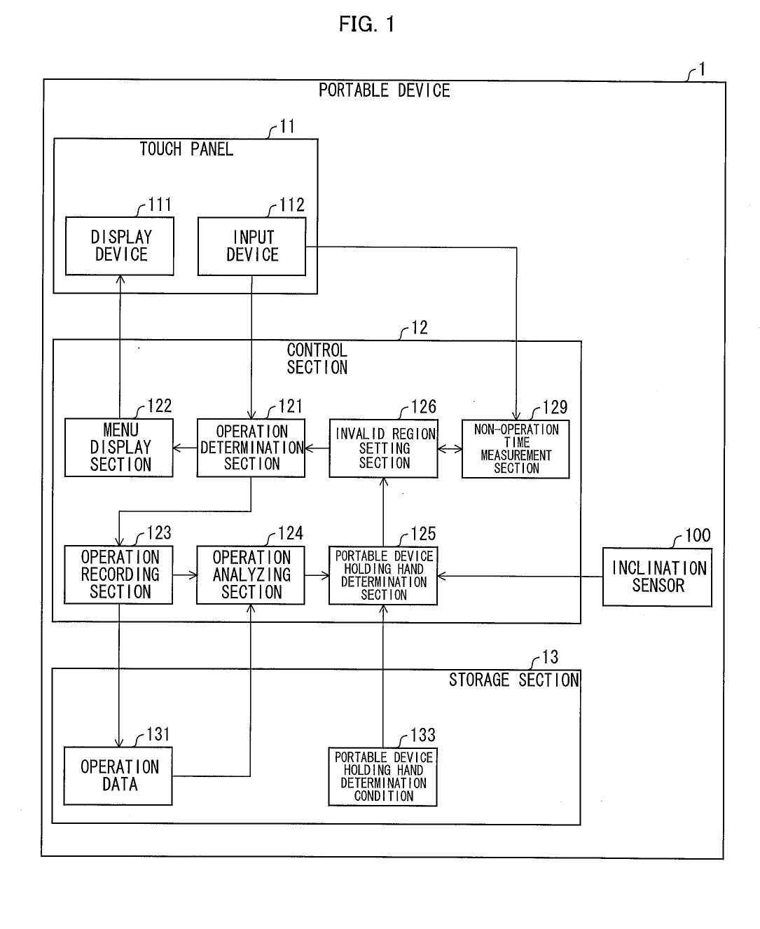

FIG. 1 is a block diagram illustrating a substantial part of a configuration of a portable device 1 according to Embodiment 1 of the present invention. The portable device 1 is a device having a size and a shape each of which allows the device to be operated with one hand that is holding a housing of the device. As illustrated in FIG. 1, the portable device 1 includes a touch panel 11, a control section 12, a storage section 13, and an inclination sensor (inclination detection section) 100. The touch panel 11 includes a display device 111 for displaying an image in accordance with an instruction of the control section 12 and an input device 112 for receiving an input operation of a user. A display surface of the display device 111 also serves as an input surface of the input device 112, and receives a touch operation of the user with respect to the display surface as an input operation with respect to the portable device 1. The control section 12 collectively controls sections provided in the portable device 1, and includes an operation determination section 121, a menu display section (display section) 122, an operation recording section 123, an operation analyzing section 124, a portable device holding hand determination section 125, an invalid region setting section (resetting section) 126, and a non-operation time measurement section 129. The storage section 13 stores therein various data which the portable device 1 uses. In an example shown in FIG. 1, the storage section 13 stores therein operation data 131 indicative of a trajectory of a user operation and a portable device holding hand determination condition 133 under which a hand with which the portable device 1 is held is determined. The inclination sensor 100 is provided so as to specify a posture in which the portable device 1 is held. Note that the inclination sensor 100 can be a gyrosensor, an acceleration sensor, or the like.

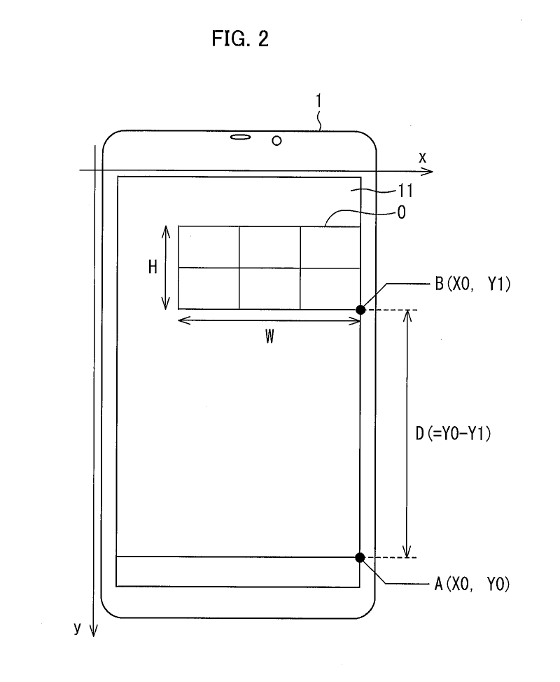

The operation determination section 121 determines what operation is carried out with respect to the portable device 1 by an input received by the input device 112. For example, in a case where the input device 112 receives a drag operation starting from either a right edge or a left edge of the display surface of the display device 111 (operation to slide a contact position while maintaining a state of contact with the display surface), the operation determination section 121 determines that a menu display operation which is an operation to display a menu is carried out. Note that the operation to display the menu is not limited to the above drag operation. The menu display section 122 which is notified by the operation determination section 121 that the menu display operation is carried out causes the display device 111 to display the menu. Specifically, the menu display section 122 displays a screen as illustrated in FIG. 2. In an example shown in FIG. 2, a menu object O (hereinafter, referred to as a “menu”) is displayed. This menu extends from an edge of the display surface toward a center of the display surface, and includes a plurality of items (six items in this example). By selecting a desired item, the user allows the portable device 1 to carry out a process corresponding to the selected desired item. The operation recording section 123 records the operation data 131 indicative of contents of the input operation received by the input device 112. The operation analyzing section 124 analyzes the operation data 131. The portable device holding hand determination section 125 determines a portable device holding hand from a result of the analysis by the operation analyzing section 124 in accordance with the portable device holding hand determination condition 133. The invalid region setting section 126 sets an invalid region for a position corresponding to a result of the determination by the portable device holding hand determination section 125, notifies the operation determination section 121 of the set invalid region, and instructs the operation determination section 121 not to receive an operation with respect to the invalid region, so that an operation carried out in the invalid region is invalidated. Note that how to invalidate the operation is not limited to this. The operation can be invalidated by, for example, controlling the input device 112 so that the operation determination section 121 is not notified of the operation carried out in the invalid region. Alternatively, control can be carried out so that an object to be operated is not displayed in the invalid region.

<Display of Menu and Setting of Invalid Region>

In a screen example of FIG. 2, coordinates at a lower right corner of a display surface are reference coordinates A (X0, Y0), and coordinates at a lower right corner of a menu are a menu reference point B (X0, Y1). Further, a width of the menu is indicated by W, a height of the menu is indicated by H, and a distance from the reference coordinates A to the menu reference point B is indicated by D (D=Y0−Y1). In a case where the above parameters (W, H, and D) together with image data of an object O are stored in advance, it is possible to carry out display as illustrated in FIG. 2. Note that, Y1, which is a y coordinate of the menu reference point B, is preferably set to be identical or close to a y coordinate of a start point of a menu display operation so that an item can be smoothly selected with a finger (typically, a thumb) that carries out the menu display operation. Note also that, in a case where the drag operation starting from a left edge of the display surface is carried out, the menu is displayed from the left edge of the display surface.

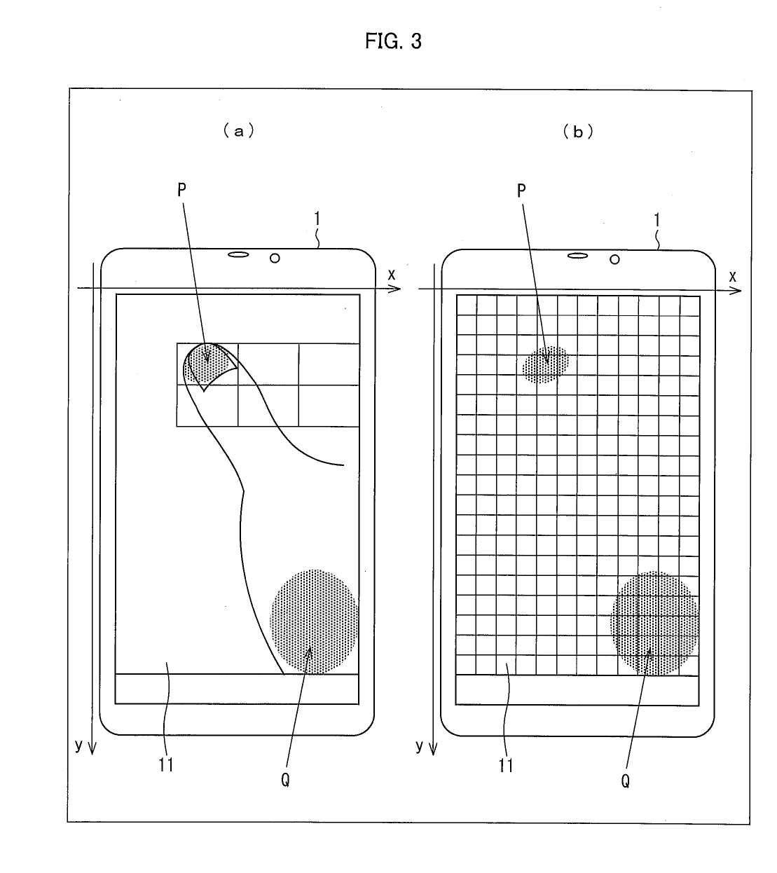

Next, the following description discusses setting of an invalid region with reference to FIGS. 3 through 5. FIG. 3 is a diagram illustrating a region in which an operational error easily occurs. As illustrated in (a) and (b) of FIG. 3, in a case where a user attempts to touch a region P of the menu with a thumb while holding the portable device 1 with a right hand, a region Q is easily erroneously touched with a palm (root portion of the thumb).

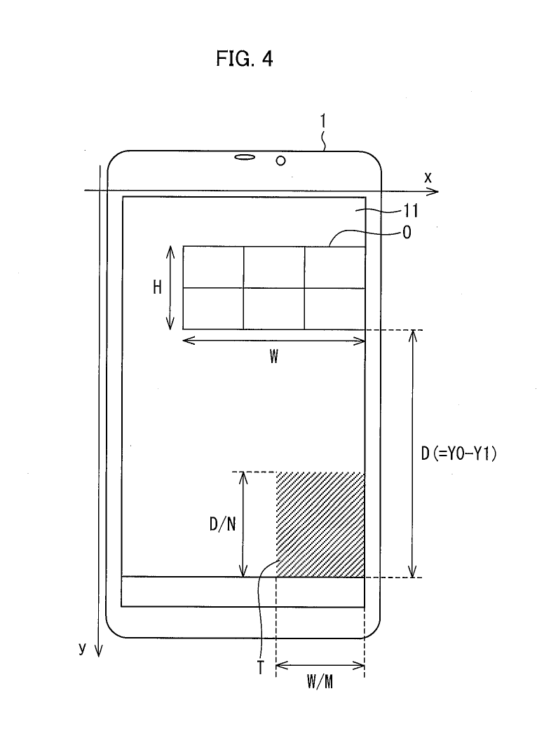

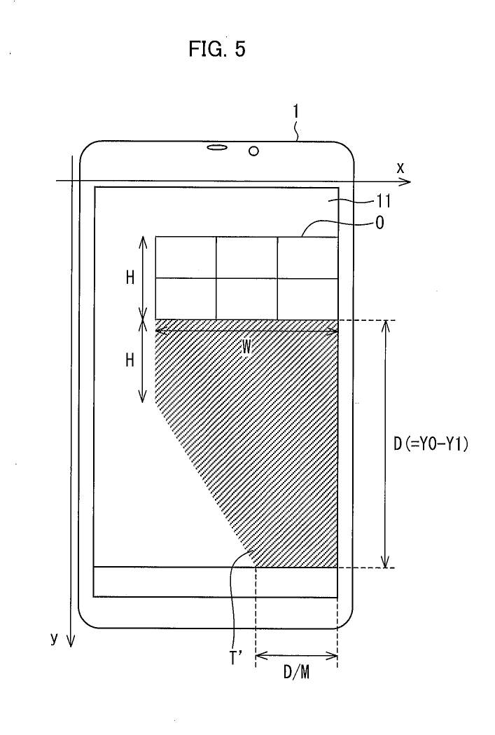

Subsequently, the following description discusses setting of the invalid region with reference to FIGS. 4 and 5. An invalid region T of FIG. 4 is an invalid region that is set when the portable device 1 is held with the right hand. The invalid region T is set at a lower right corner of the display surface so as to be lower than the menu (in a y-axis normal direction) and to include the region Q (see FIG. 3) in which an operational error easily occurs. In an example of FIG. 4, a height of the invalid region T is indicated by D/N and a width of the invalid region T is indicated by W/M. Note that N and M are each an integer that is not less than 1. In view of the above, a range of the invalid region T is expressed as follows:

(N×X0−W)/N<X<X0, ((N−1)×Y0+Y1)/N<Y<Y0

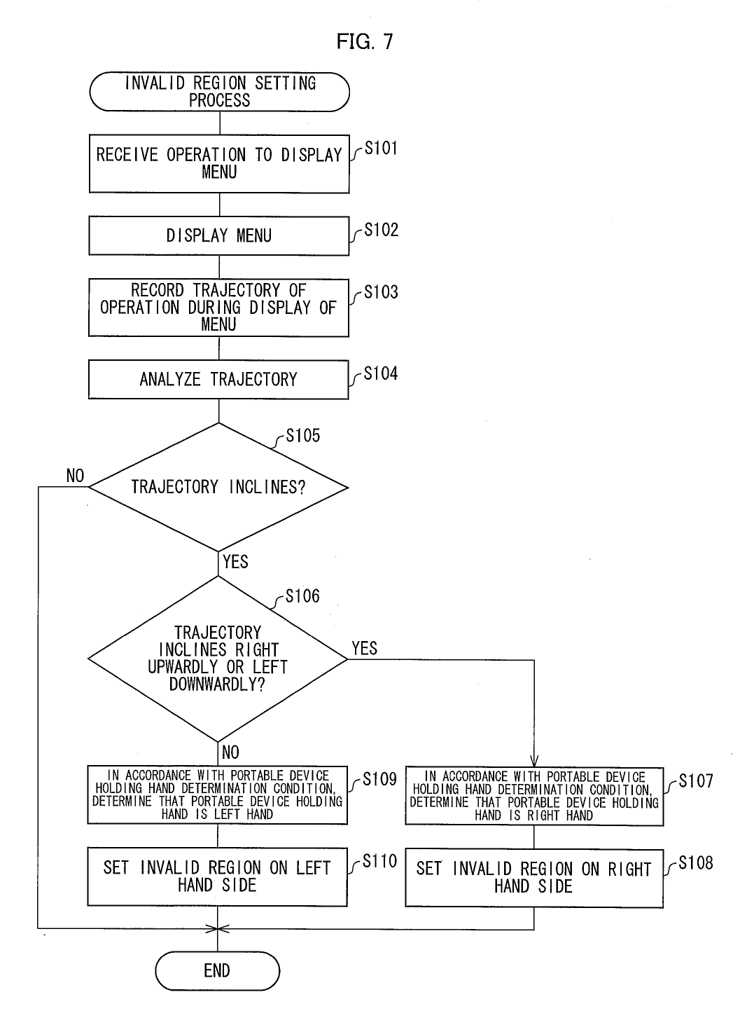

Furthermore, as illustrated in FIG. 5, an invalid region T′ having a pentagonal shape is set so as to be lower than the menu and to include the region Q in which an operational error easily occurs. The invalid region T′ more widely covers a region closer to the menu as compared with the invalid region T of FIG. 4. This makes it more difficult for an operational error to occur in the invalid region T′. Each of the invalid regions T and T′ covers the region Q, has a height that does not reach a height of the menu, and has a width that is not more than the width W of the menu. This makes it possible to receive an operation with respect to a region outside the invalid region while preventing occurrence of an operational error. As in the case of the above example, the invalid region which is set when the portable device 1 is held with a left hand only needs to be set on the portable device holding hand side (at a lower left corner of the display surface) so as to be lower than the menu. Note that the invalid region only needs to be a region that corresponds to a portable device holding hand and covers a region in which an operational error easily occurs, and may have not only the shape of the above example but also another shape. Note, however, that the invalid region preferably covers only a region which corresponds to a portable device holding hand and in which an operational error particularly easily occurs, and is preferably not set to be unnecessarily wide. According to such a configuration, also in a state in which the invalid region is set, it is possible to receive an input operation of a user in a wider range as compared with a technique of Patent Literature 1 (FIGS. 3, 7, etc. of Patent Literature 1) for setting a belt-shaped invalidated region along a side of a rectangular display surface.

<Method for Determining Portable Device Holding Hand>

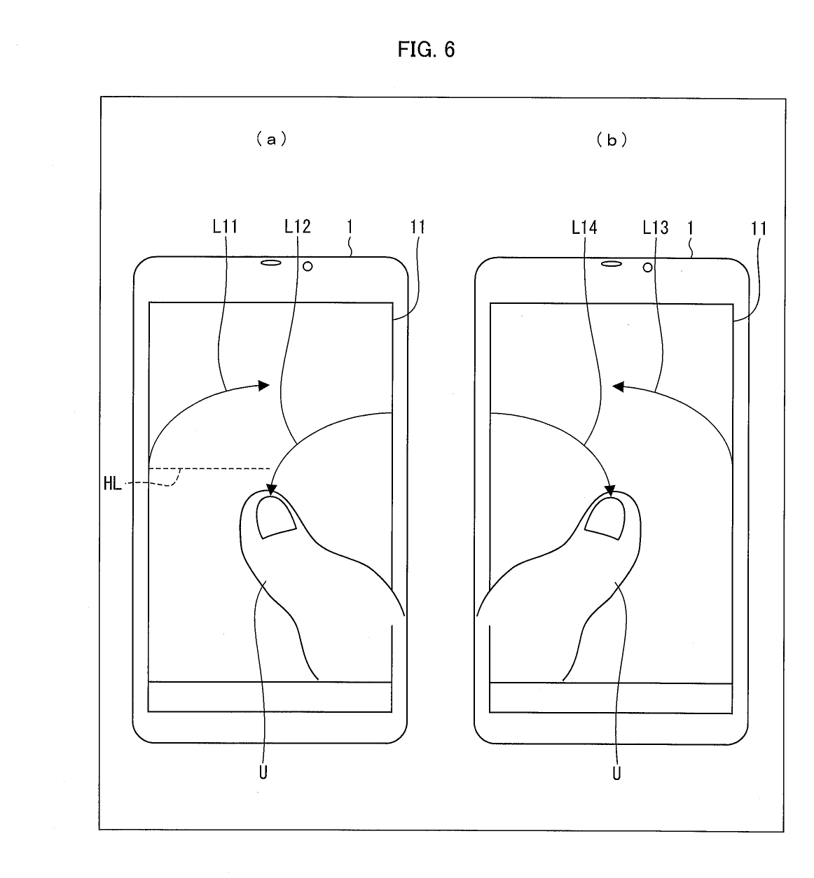

A method for determining a portable device holding hand is described below with reference to FIG. 6 illustrating a trajectory of a menu display operation. As described earlier, the menu display operation is a drag operation starting from either a right edge or a left edge of a display surface. Therefore, as illustrated in (a) of FIG. 6, the trajectory drawn when the menu display operation is carried out with a right hand is an arc-shaped trajectory L11 extending right upwardly from the left edge of the display surface, or an arc-shaped trajectory L12 extending left downwardly from the right edge of the display surface. Meanwhile, as illustrated in (b) of FIG. 6, the trajectory drawn when the menu display operation is carried out with a left hand is an arc-shaped trajectory L14 extending right downwardly from the left edge of the display surface, or an arc-shaped trajectory L13 extending left upwardly from the right edge of the display surface. In the following description, the arc-shaped trajectory extending right upwardly from the left edge is referred to as a right upward trajectory, an arc-shaped trajectory extending left downwardly from the right edge is referred to as a left downward trajectory, an arc-shaped trajectory extending right downwardly from the left edge is referred to as a right downward trajectory, and an arc-shaped trajectory extending left upwardly from the right edge is referred to as a left upward trajectory.

In view of the above description, in a case where the trajectory of the menu display operation extends right upwardly or left downwardly (positively inclines), it can be assumed that the portable device holding hand is the right hand. Meanwhile, in a case where the trajectory of the menu display operation extends right downwardly or left upwardly (negatively inclines), it can be assumed that the portable device holding hand is the left hand. Thus, in a case where the inclination of the trajectory of the menu display operation can be specified by analyzing the menu display operation, the portable device holding hand can be determined.

<Invalid Region Setting Process Carried out by Portable Device 1>

In an invalid region setting process illustrated in FIG. 7, the input device 112 receives an instruction to display a menu (S101), and the operation determination section 121 notifies the menu display section 122 of receipt of an operation to display the menu. The operation determination section 121 also transmits, to the operation recording section 123, data indicative of a trajectory of the operation to display the menu. Then, the menu display section 122 displays the menu in the display device 111 (S102; a display step). Meanwhile, the operation recording section 123 records the data indicative of the trajectory of the operation as the operation data 131 (S103) and then notifies the operation analyzing section 124 of the recording.

Next, the operation analyzing section 124 analyzes the operation data 131 (S104) and determines whether or not the trajectory has an inclination that is greater than or equal to a given inclination (S105). Here, in a case where the operation analyzing section 124 determines that the trajectory does not have the inclination that is greater than or equal to the given inclination (NO at S105), the portable device 1 ends the process. Meanwhile, in a case where the operation analyzing section 124 determines that the trajectory has the inclination that is greater than or equal to the given inclination (YES at S015), the operation analyzing section 124 determines whether or not the trajectory inclines right upwardly or left downwardly (S106), and then notifies the portable device holding hand determination section 125 of a result of the determination.

Here, in a case where the operation analyzing section 124 determines that the trajectory inclines right upwardly or left downwardly (YES at S106), the portable device holding hand determination section 125 which is notified of the determination determines, in accordance with the portable device holding hand determination condition 133, that the portable device holding hand is the right hand (S107; a portable device holding hand determination step). Then, the portable device holding hand determination section 125 notifies the invalid region setting section 126 of a result of the determination, and then the invalid region setting section 126 sets the invalid region on the right hand side of the display surface (S108; an invalid region setting step). Meanwhile, in a case where the operation analyzing section 124 determines that the trajectory inclines left upwardly or right downwardly (NO at S106), the portable device holding hand determination section 125 which is notified of the determination determines, in accordance with the portable device holding hand determination condition 133, that the portable device holding hand is the left hand (S109; a portable device holding hand determination step). Then, the portable device holding hand determination section 125 notifies the invalid region setting section 126 of a result of the determination, and then the invalid region setting section 126 sets the invalid region on the left hand side of the display surface (S110; an invalid region setting step). The portable device 1 which has thus set the invalid region corresponding to the portable device holding hand ends the process.

From the viewpoint of an object to be displayed, the invalid region setting process described above can be expressed as a process for setting the invalid region corresponding to the result of determination of the portable device holding hand in displaying the menu. Further, from the viewpoint of a received input operation, the invalid region setting process can be expressed as a process for setting the invalid region corresponding to the result of determination of the portable device holding hand when a drag operation (operation to display the menu) starting from an edge of the display surface is carried out. The portable device 1 thus sets the invalid region at a timing at which the menu is displayed (timing at which the drag operation starting from the edge is carried out). That is, the portable device 1 sets the invalid region when an operational error may occur due to a touch of the display surface with a root portion of a thumb and thus it is highly necessary to set the invalid region (while the menu is being displayed). In other words, the portable device 1 does not set the invalid region when such an operational error as described above is less likely to occur. Such a configuration allows a period in which an input operation can be received on an entire surface of the display surface to be longer as compared with the technique of Patent Literature 1 for setting the invalid region at all times. Note that the object to be displayed only needs to be a target of the input operation and is not limited to the menu. Further, an operation to display the object only needs to start from an edge of a screen, and the operation may start from, for example, a top edge or a bottom edge of the screen.

### Embodiment 2

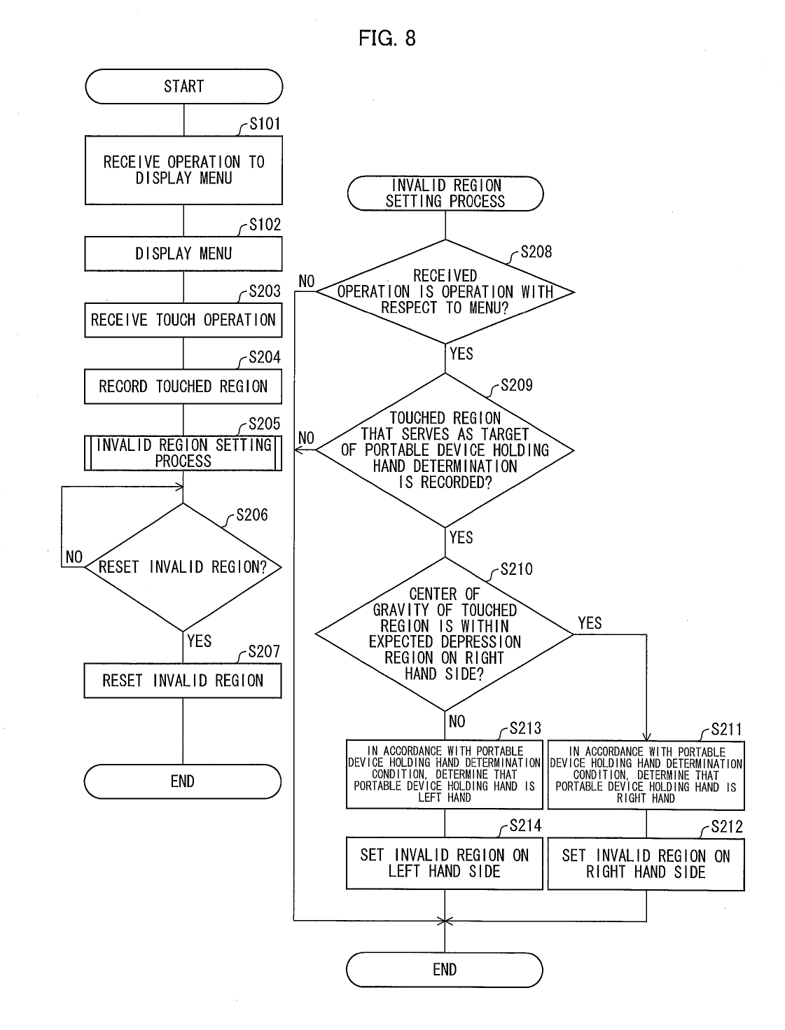

The following description of Embodiment 2 discusses, with reference to FIG. 8, an example in which the portable device 1 having the configuration illustrated in FIG. 1 sets an invalid region by determining a portable device holding hand by a method different from that of Embodiment 1. In a flowchart on a left side of FIG. 8, as in the case of the example of FIG. 7, a menu display operation is received (S101), and then a menu is displayed (S102). When an input device 112 receives a touch operation with respect to a display surface while the menu is being displayed (S203), an operation determination section 121 transmits, to an operation recording section 123, data indicative of a touched region, which is a region of the display surface which region has been touched with a finger (S203). Then, the operation recording section 123 records, in a storage section 13, data indicative of the touched region as operation data 131 (S204), and then notifies an operation analyzing section 124 of the recording.

This causes an invalid region setting process to be carried out (S205). In a case where an invalid region is set by the invalid region setting process, an invalid region setting section 126 determines whether or not to reset the invalid region (S206). At S206, for example, in a case where (i) a user operation to reset the invalid region, (ii) termination of display of the menu, (iii) termination of execution of application software that is operated by the displayed menu, or the like is detected, the invalid area setting section 126 may determine to reset the invalid region. The invalid area setting section 126 which determines to reset the invalid region (YES at S206) instructs the operation determination section 121 to reset the invalid region (S207), so that the portable device 1 ends the process.

Subsequently, the following description specifically discusses the invalid region setting process of S205. As illustrated on a right side of FIG. 8, in the invalid region setting process of Embodiment 2, the operation analyzing section 124 analyzes the operation data 131 and determines whether or not the operation received at S203 is an operation #1 with respect to the menu (S208). Specifically, in a case where a touched position indicated by the operation data 131 is within a region in which the menu is displayed, the operation analyzing section 124 determines that the received operation is the operation #1. Meanwhile, in a case where the touched position is outside the region in which the menu is displayed, the operation analyzing section 124 determines that the received operation is not the operation #1.

Here, in a case where the operation analyzing section 124 determines that the received operation is not the operation #1 (NO at S208), the portable device 1 ends the invalid region setting process. Meanwhile, in a case where the operation analyzing section 124 determines that the received operation is the operation #1 (YES at S208), the operation analyzing section 124 further analyzes the operation data 131 and then determines whether or not a touched region which is a target of determination of a portable device holding hand is recorded (S209). Here, in a case where a touched region which is different from that within the region in which the menu is displayed is recorded, a result of determination by the operation analyzing section 124 is YES. Meanwhile, in a case where that touched region is not recorded, the result of determination by the operation analyzing section 124 is NO. That is, the operation analyzing section 124 determines at S209 whether or not a touch operation #2 different from the operation with respect to the menu has been carried out.

In a case where the operation analyzing section 124 determines at S209 that the touched region which is the target of determination of the portable device holding hand is not recorded (NO at S209), the portable device 1 ends the invalid region setting process. In this case, the invalid region is not set because the portable device 1 seems to be held with both hands. Meanwhile, in a case where the operation analyzing section 124 determines that the touched region which is the target of determination of the portable device holding hand is recorded (YES at S209), the operation analyzing section 124 notifies a portable device holding hand determination section 125 of a result of the determination and information (e.g., coordinates) indicative of a position of the center of gravity of the touched region which is the target of determination of the portable device holding hand.

Next, the portable device holding hand determination section 125 determines, in accordance with the information notified by the operation analyzing section 124, whether or not the center of gravity of the touched region is within an expected depression region (expected contact region) on a right hand side (S210). Note here that the expected depression region refers to a region of the display surface which region is set in advance as a region that is highly likely to be touched with a user's finger during an input operation with respect to the menu. The expected depression region which is set in advance includes: a right hand side expected depression region which is highly likely to be touched when the portable device 1 is held with a right hand; and a left hand side expected depression region which is highly likely to be touched when the portable device 1 is held with a left hand. For example, a region at a lower right corner of the display surface which region includes the region Q illustrated in FIG. 3 can be set as the right hand side expected depression region, and a region at a lower left corner of the display surface which region is identical in shape to the right hand side expected depression region can be set as the left hand side expected depression region. Note that information indicative of a range of the expected depression region only needs to be recorded in the storage section 13 as a portable device holding hand determination condition 133 which is associated with information indicative of whether the range corresponds to holding of the device with the right hand (the right hand side) or holding of the device with the left hand (the left hand side).

The expected depression region only needs to be set so as to cover a corner part on the portable device 1 holding hand side (a root portion of a thumb, see FIG. 3) when a user holds the portable device 1 with one hand. For example, a range of the expected depression region can be set to be identical to those of the invalid regions illustrated in FIGS. 4 and 5. That is, the right hand side expected depression region can be set as below (see FIG. 4).

(N×X0−W)/N<X<X0,((N−1)×Y0+Y1)/N<Y<Y0

Same applies to the left hand side expected depression region. As a matter of course, the expected depression region is not limited to the above example provided that the expected depression region includes a region that is highly likely to be touched during the input operation with respect to the menu. For example, as in the case of the invalid region of FIG. 5, a region that extends from a corner (lower right corner or lower left corner) on the portable device 1 holding hand side toward the menu so as to be greater in width can be set as the expected depression region. As in the case of the invalid region of FIG. 5, the expected depression region can have a shape exemplified by not only a rectangular shape and a pentagonal shape but also various shapes such as a trapezoid, a circle, a triangle, and a polygon not less than a hexagon. Moreover, the expected depression region and the invalid region can be identical to or different from each other.

Here, in a case where the portable device holding hand determination section 125 determines, in accordance with the portable device holding hand determination condition 133, that the center of gravity of the touched region is within the right hand side expected depression region (YES at S210), the portable device holding hand determination section 125 determines that the portable device 1 is held with the right hand (S211; a portable device holding hand determination step). Then, the portable device holding hand determination section 125 notifies the invalid region setting section 126 of a result of the determination, and then the invalid region setting section 126 sets the invalid region on the right hand side of the display surface (S212; an invalid region setting step). Meanwhile, in a case where the portable device holding hand determination section 125 determines that the center of gravity of the touched region is within the left hand side expected depression region (NO at S212), the portable device holding hand determination section 125 determines that the portable device 1 is held with the left hand (S213; a portable device holding hand determination step), and then notifies the invalid region setting section 126 of a result of the determination. Then, the invalid region setting section 126 sets the invalid region on the left hand side of the display surface (S214; an invalid region setting step). The portable device 1 which has thus set the invalid region corresponding to the portable device holding hand ends the process.

### Embodiment 3

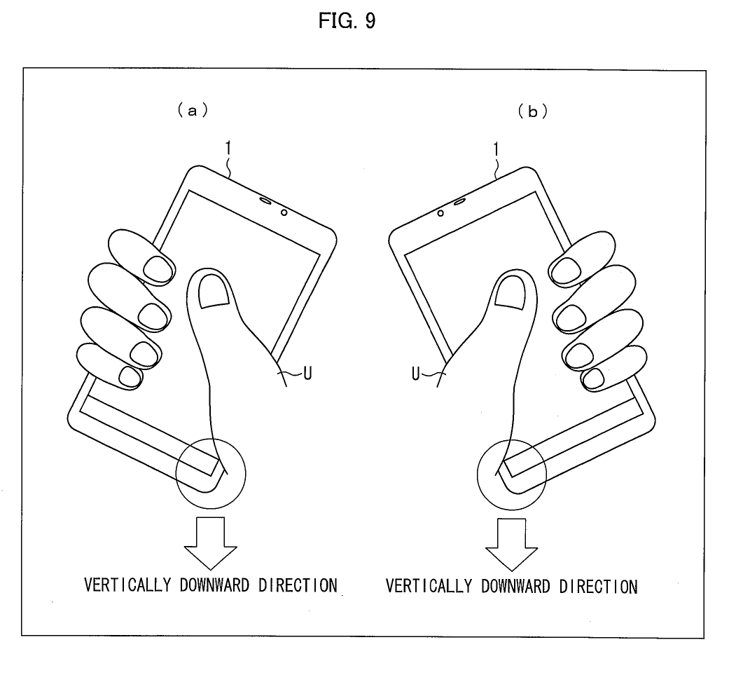

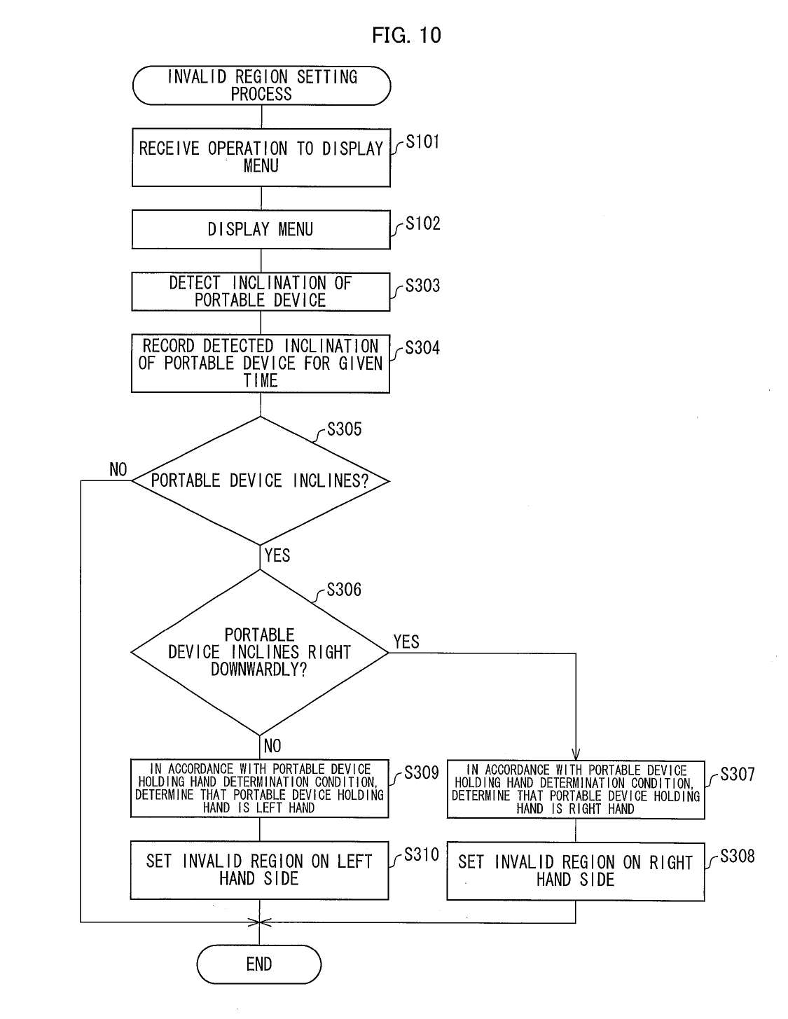

The following description of Embodiment 3 discusses, with reference to FIGS. 9 and 10, an example in which the portable device 1 having the configuration illustrated in FIG. 1 sets an invalid region by determining a portable device holding hand by a method different from those of Embodiments 1 and 2. As illustrated in (a) of FIG. 9, when the portable device 1 is held with a right hand, the portable device 1 inclines right downwardly so that a corner of the portable device 1 which corner is close to a root of a thumb (a corner circled in (a) of FIG. 9) is located so as to be more vertically downward than the other corners. Meanwhile, as illustrated in (b) of FIG. 9, when the portable device 1 is held with a left hand, the portable device 1 inclines left downwardly. This is because of the following reason: In order to operate the portable device 1 while firmly holding the portable device 1, it is necessary to fix the portable device 1 by pressing an arm tightly to a body side so as to bring an elbow into close contact with the body side. Further, the portable device 1 is operated with the thumb while, in a state in which a palm and the portable device 1 are in close contact with each other, left and right edges of the portable device 1 are being held so that one of the left and right edges of the portable device 1 is sandwiched between the root of the thumb of the palm (an adductor muscle of the thumb) and the first joints of the little finger, the third finger, the second finger, and the index finger so as to be along a lower part of the palm. Therefore, either one of the left and right edges of the portable device 1 is oriented downward.

A method of Embodiment 3 for determining a portable device holding hand uses the inclination of the portable device 1 as described above. In a case where the portable device 1 inclines right downwardly for a time longer than or equal to a given time, it is determined that the portable device 1 is held with the right hand. Meanwhile, in a case where the portable device 1 inclines left downwardly for a time longer than or equal to a given time, it is determined that the portable device 1 is held with the left hand. More specifically, the portable device holding hand is determined with use of a portable device holding hand determination condition 133 in which holding of the portable device 1 with the right hand is associated with a right downward inclination of the portable device 1 for a time longer than or equal to a given time, and holding of the portable device 1 with the left hand is associated with a left downward inclination of the portable device 1 for a time longer than or equal to a given time. Note that the inclination is calculated in accordance with data measured by an inclination sensor 100 (see FIG. 1).

In an invalid region setting process of FIG. 10, as in the case of the example of FIG. 7, a menu display operation is received (S101), and then a menu is displayed (S102). In a case where an operation determination section 121 determines that the menu display operation is carried out, the operation determination section 121 gives a notification of a result of the determination to a portable device holding hand determination section 125. The portable device holding hand determination section 125 which has received the notification detects the inclination of the portable device 1 from the data measured by the inclination sensor 100 (S303), and then records, for a given time, information indicative of the inclination (S304). The portable device holding hand determination section 125 which has terminated the recording for the given time determines, in accordance with recorded information, whether or not the portable device 1 inclines (S305). Specifically, in a case where the portable device 1 inclines right downwardly or left downwardly for a time longer than or equal to a given minimum time, the portable device holding hand determination section 125 determines that the portable device 1 inclines. Here, in a case where the portable device holding hand determination section 125 determines that the portable device 1 does not incline (NO at S305), the portable device 1 ends the process without setting the invalid region. Meanwhile, the portable device holding hand determination section 125 which determines that the portable device 1 inclines (YES at S305) determines whether or not the portable device 1 inclines right downwardly (S306).

Here, the portable device holding hand determination section 125 which determines that the portable device 1 inclines right downwardly (YES at S306) determines, in accordance with the portable device holding hand determination condition 133, that the portable device 1 is held with the right hand (S307; a portable device holding hand determination step). Then, the portable device holding hand determination section 125 notifies an invalid region setting section 126 of a result of the determination, and then the invalid region setting section 126 sets the invalid region on a right hand side of a display surface (S308; an invalid region setting step). Meanwhile, the portable device holding hand determination section 125 which determines that the portable device 1 inclines left downwardly (NO at S306) determines that the portable device 1 is held with the left hand (S309; a portable device holding hand determination step), and then notifies the invalid region setting section 126 of a result of the determination. Then, the invalid region setting section 126 sets the invalid region on a left hand side of the display surface (S310; an invalid region setting step). The portable device 1 which has thus set the invalidated region corresponding to the portable device holding hand ends the process.

### Another Example of Method for Determining Portable Device Holding Hand

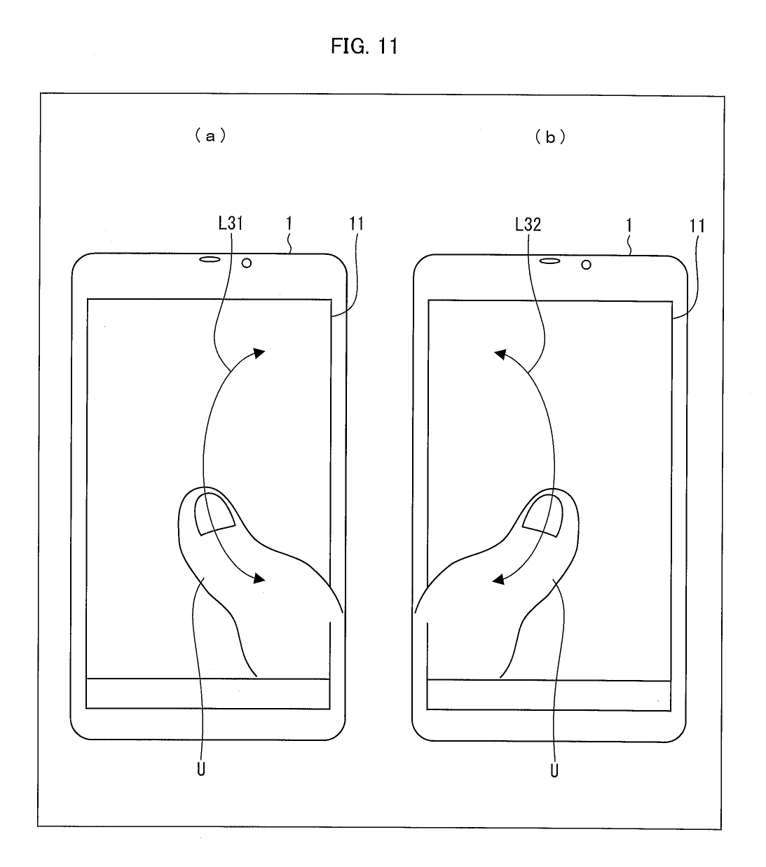

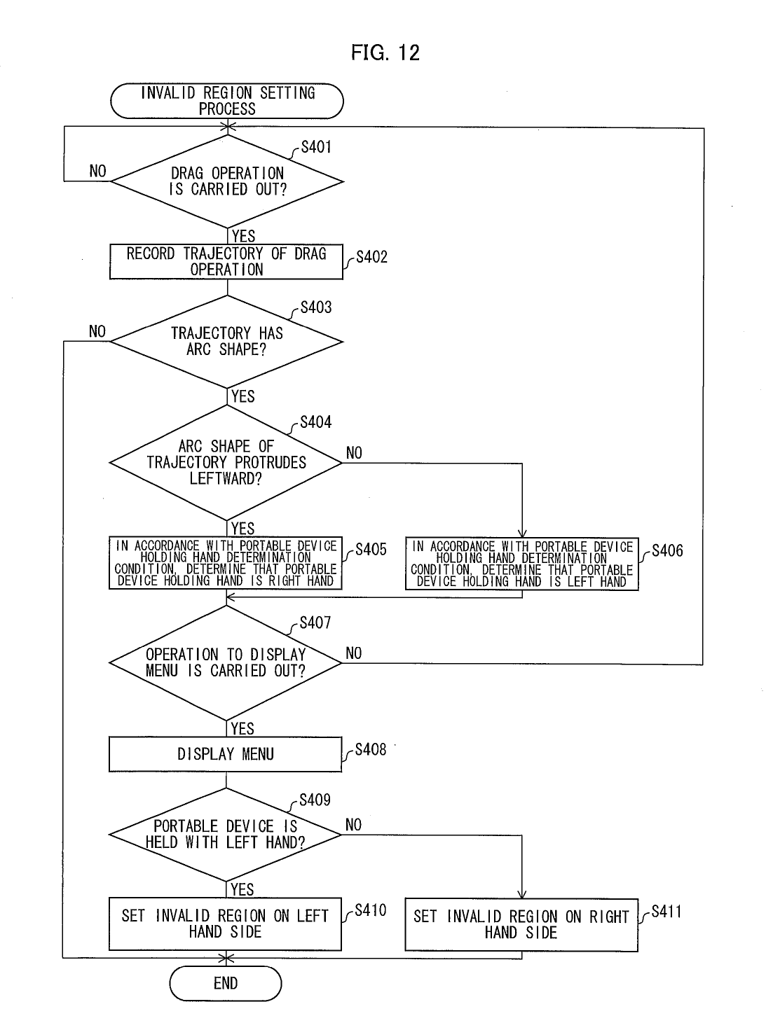

The following description discusses, with reference to FIGS. 11 and 12, still another example of a method for determining a portable device holding hand. FIG. 11 is a diagram illustrating a trajectory of a vertical drag operation. FIG. 12 is a flowchart showing an example of an invalid region setting process carried out in a case where a portable device holding hand is determined in accordance with analysis of a trajectory of a drag operation. As illustrated in (a) of FIG. 11, in a case where the vertical drag operation is carried out with a thumb of a right hand, the thumb pivots on a root thereof, so that a trajectory drawn on a display surface has an arc shape protruding leftward. Meanwhile, in a case where the vertical drag operation is carried out with a thumb of a left hand, the trajectory drawn on the display surface has an arc shape protruding rightward. Therefore, the portable device holding hand can be determined by specifying in which direction the trajectory of the drag operation protrudes. That is, the portable device holding hand can be determined under the portable device holding hand determination condition 133 in which the trajectory of the drag operation which trajectory protrudes leftward indicates that the portable device 1 is held with the right hand, and the trajectory of the drag operation which trajectory protrudes to rightward indicates that the portable device 1 is held with the left hand.

In the flowchart of FIG. 12, first, the operation determination section 121 waits for the drag operation (S401). When the operation determination section 121 determines, from a trajectory of an operation received by an input device 112, that the drag operation is carried out (YES at S401), the operation determination section 121 transmits, to an operation recording section 123, data indicative of the trajectory, and causes the operation recording section 123 to record the data as operation data 131 (S402). The operation recording section 123 notifies an operation analyzing section 124 that the operation data 131 is recorded therein.

Next, the operation analyzing section 124 analyzes the operation data 131 so as to determine whether or not the trajectory has an arc shape (S403). In a case where the operation analyzing section 124 determines that the trajectory does not have the arc shape (NO at S403), the portable device 1 ends the invalid region setting process. Meanwhile, the operation analyzing section 124 which determines that the trajectory has the arc shape (YES at S403) determines whether or not such the arc shape of the trajectory protrudes leftward (S404).

Here, the operation analyzing section 124 which determines that the arc shape of the trajectory protrudes leftward (YES at S404) notifies the portable device holding hand determination section 125 of a result of the determination. Then, the portable device holding hand determination section 125 determines, in accordance with the portable device holding hand determination condition 133, that the portable device 1 is held with the right hand (S405; a portable device holding hand determination step), and then notifies the invalid region setting section 126 of a result of the determination. Meanwhile, the operation analyzing section 124 which determines that the arc shape of the trajectory protrudes rightward (NO at S404) notifies the portable device holding hand determination section 125 of a result of the determination. Then, the device holding hand determination section 125 determines, in accordance with the portable device holding hand determination condition 133, that the portable device 1 is held with the left hand (S406; a portable device holding hand determination step), and then notifies the invalid region setting section 126 of a result of the determination.

Thereafter, the operation determination section 121 which determines that an operation to display the menu is carried out (YES at S407) notifies each of a menu display section 122 and the invalid region setting section 126 of a result of the determination. Then, the process proceeds to S408. Meanwhile, in a case where no operation to display the menu is carried out, the process returns to S401. This makes it possible to set the invalidated region corresponding to a hand with which the portable device is held just before the menu display operation is carried out.

At S408, the menu display section 122 displays the menu. Then, the invalid region setting section 126 confirms, in accordance with contents of the final notification by the portable device holding hand determination section 125, whether or not the portable device 1 is held with the left hand (S409; a portable device holding hand determination step). In a case where the portable device 1 is held with the left hand, the invalid region setting section 126 sets the invalid region on a left hand side of the display surface (S410; an invalid region setting step). Meanwhile, in a case where the portable device 1 is held with the right hand, the invalid region setting section sets the invalidated region on a right hand side of the display surface (S411; an invalid region setting step). This causes the portable device 1 to end the process. Note that detection of the inclination and determination of the portable device holding hand can be carried out before the menu is displayed. This allows a shorter time between display of the menu and setting of the invalid region. This also makes it possible to concurrently carry out display of the menu and setting of the invalid region.

### Resetting of Invalid Region

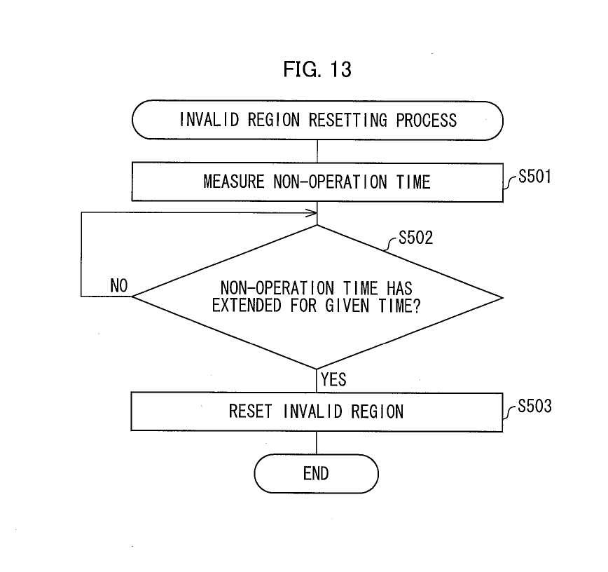

The following description discusses resetting of an invalid region with reference to FIG. 13. A flowchart of FIG. 13 illustrates a process to be carried out after the invalid region is set. The invalid region setting section 126 which has set the invalid region gives a non-operation time measurement section 129 an instruction to measure a non-operation time. In accordance with the instruction, the non-operation measurement section 129 starts measuring the non-operation time (S501). Note that the “non-operation time” herein refers to a duration of a state in which no input operation with respect to the input device 112 is carried out.

Then, the non-operation time measurement section 129 confirms whether or not the non-operation time has extended for a time longer than or equal to a given time (S502). The non-operation time measurement section 129 which confirms that the non-operation time has extended for the time longer than or equal to the given time (YES at S502) gives the invalid region setting section 126 a notification of a result of the confirmation. The invalidated region setting section 126 which receives the notification instructs the operation determination section 121 to reset the invalid region (S503). This causes the portable device 1 to end the invalid region resetting process.

### Modified Example

A method for determining a portable device holding hand in accordance with a trajectory of a drag operation is not limited to the examples of the above embodiments. For example, the portable device holding hand can be determined by registering, in advance, (i) a trajectory drawn when the drag operation is carried out with a right hand and (ii) a trajectory drawn when the drag operation is carried out with a left hand as trajectories for determination, and carrying out pattern-matching between the registered trajectories and a detected trajectory of the drag operation. Further, it is only necessary to use, in combination, the methods for determining the portable device holding hand which are described in the above embodiments, employ the methods in predetermined order of priority, and adopt a result of determination of the portable device holding hand which result is obtained first. This makes it possible to set the invalid region by, for example, determining the portable device holding hand from the trajectory of the drag operation in a case where the portable device holding hand cannot be determined from the inclination.

### Software Implementation Example

Control blocks of the portable device 1 (particularly, the control section 12) may be realized by a logic circuit (hardware) provided in an integrated circuit (IC chip) or the like or may be realized by software as executed by a CPU (Central Processing Unit). In the latter case, the portable device 1 includes: a CPU that executes instructions of a control program that is software realizing the foregoing functions; ROM (Read Only Memory) or a storage device (each referred to as “storage medium”) storing the control program and various kinds of data in such a form that they are readable by a computer (or a CPU); and RAM (Random Access Memory) that develops the control program in executable form. The object of the present invention can be achieved by a computer (or a CPU) reading and executing the control program stored in the storage medium. The storage medium may be “a non-transitory tangible medium” such as a tape, a disk, a card, a semiconductor memory, and a programmable logic circuit. Further, the control program may be supplied to or made available to the computer via any transmission medium (such as a communication network and a broadcast wave) which enables transmission of the control program. Note that the present invention can also be implemented by the control program in the form of a computer data signal embedded in a carrier wave which is embodied by electronic transmission.

### CONCLUSION

A portable device 1 according to Aspect 1 of the present invention is a portable device for receiving an input operation with respect to a display surface thereof on which to display an image, the portable device including: a display section (menu display section 122) for, in accordance with a given input operation, displaying, in a partial region of the display surface, an input target object (menu) which serves as a target of the input operation; a portable device holding hand determination section (portable device holding hand determination section 125) for determining which of a right hand and a left hand is a portable device holding hand; and an invalid region setting section (invalid region setting section 126) for, while the input target object is being displayed, invalidating the input operation with respect to a region in which no input target object is displayed and which corresponds to a result of the determination by the portable device holding hand determination section. According to the configuration, a region which corresponds to a result of determination of a portable device holding hand is set, while the input target object (hereinafter, referred to as an “object” as necessary) is being displayed, as an invalid region in which an input operation with respect to that region is invalidated. This makes it possible to prevent an operational error that is caused in a case where a region, in which the object is not displayed, is erroneously touched by a user who is carrying out the input operation with respect to the object. Further, since the invalid region is set while the object is being displayed, the input operation can be received on an entire display surface for a period before the object is displayed.

In Aspect 2 of the present invention, the portable device 1 according to Aspect 1 of the present invention can be configured such that: the invalid region setting section invalidates the input operation with respect to a region of the display surface which region is located, with respect to the input target object, (i) on a side of a user holding the portable device, and (ii) closer to the portable device holding hand determined by the portable device holding hand determination section. According to the configuration, it is possible to set an invalid region suitable for a case where the portable device is operated with one hand that is holding the portable device.

In Aspect 3 of the present invention, the portable device 1 according to Aspect 1 or 2 of the present invention is configured such that: the given input operation is the input operation which has a given trajectory with respect to the display surface; and the portable device holding hand determination section determines the portable device holding hand from a trajectory of the input operation that causes the input target object to be displayed. According to the configuration, since the portable device holding hand is determined with use of a trajectory of an input operation by which the object is displayed, it is unnecessary for the portable device 1 to have any special configuration for determination of the portable device holding hand, and for a user to carry out an operation to determine the portable device holding hand. Further, it is also possible to concurrently carry out display of the object and setting of the invalid region.

In Aspect 4 of the present invention, the portable device 1 according to Aspect 1 or 2 of the present invention can be configured such that: in a case where a contact with respect to either one of a first expected contact region and a second expected contact region is detected concurrently or sequentially with the input operation with respect to the input target object, the first expected contact region being set, on the display surface in advance, as a region which is highly likely to be touched with a finger of the user while the input operation is being carried out with respect to the input target object with the right hand, the second expected contact region being set, on the display surface in advance, as a region which is highly likely to be touched with the finger of the user while the input operation is being carried out with respect to the input target object with the left hand, the portable device holding hand determination section determines the portable device holding hand in accordance with which of the first and second expected contact regions has been subjected to the contact; and the invalid region setting section invalidates the input operation with respect to a region including the first or second expected contact region in which the contact has been detected. According to the configuration, it is unnecessary for the portable device 1 to have any special configuration for determination of the portable device holding hand, and for a user to carry out an operation to determine the portable device holding hand, and a region including the expected contact region is set as an invalid region. This makes it possible to appropriately prevent an operational error that occurs when the input operation with respect to the object is carried out.

In Aspect 5 of the present invention, the portable device 1 according to Aspect 1 or 2 of the present invention is configured to further include: an inclination detection section for measuring an inclination of the portable device 1, the portable device holding hand determination section determining the portable device holding hand, the portable device holding hand being a hand with which the portable device 1 is held, from the inclination measured by the inclination detection section. Here, in a case where the portable device 1 is operated with one hand that is holding the portable device, the portable device 1 is highly likely to be held in a state in which the portable device 1 inclines in accordance with the portable device holding hand. Therefore, according to the configuration, it is possible to determine the portable device holding hand in a state in which the portable device 1 is operated with one hand.

In Aspect 6 of the present invention, the portable device 1 according to Aspect 1 or 2 of the present invention can be configured such that, in a case where a trajectory of a vertical drag operation with respect to the display surface has an arc shape protruding leftward, the portable device holding hand determination section determines that the portable device is held with the right hand, and in a case where the trajectory of the vertical drag operation with respect to the display surface has an arc shape protruding rightward, the holding hand determination section determines that the portable device is held with the left hand. According to the configuration, it is possible to determine the portable device holding hand without the need for the portable device 1 to be specially configured to include a sensor, for example.

In Aspect 7 of the present invention, the portable device 1 according to any one of Aspects 1 through 6 of the present invention can be configured to further include: a resetting section (invalid region setting section 126) for resetting the invalid region in a case where no input operation continues to be detected for a given time after the invalid region is set by the invalid region setting section. According to the configuration, in a case where an input operation is not carried out with respect to an object that has been displayed, it is possible to automatically reset the invalid region so that a state of the portable device 1 is returned to a state which allows an input operation widely using an input surface to be carried out.

A portable device 1 according to Aspect 8 of the present invention is a portable device for receiving an input operation with respect to a display surface thereof on which to display an image, the portable device comprising: a portable device holding hand determination section for determining, from a trajectory of a drag operation starting from an edge of the display surface, which of a right hand and a left hand is a portable device holding hand; and an invalid region setting section for, when the portable device holding hand determination section determines the portable device holding hand, setting a region of the display surface which region corresponds to a result of the determination of the portable device holding hand as an invalid region in which an input operation with respect to the region is made invalid. Further, a control method according to Aspect 10 of the present invention is a method for controlling a portable device 1 for receiving an input operation with respect to a display surface thereof on which to display an image, the method includes: a portable device holding hand determination step (S107, S109;S211, S213;S307, S309;S405, S406) of determining, from a trajectory of a drag operation starting from an edge of the display surface, which of a right hand and a left hand is a portable device holding hand, the portable device holding hand being a hand with which the portable device 1 is held; and an invalid region setting step (S108, S110;S212, S214;S308, S310;S409, S410, S411) of, when the portable device holding hand is determined in the portable device holding hand determination step, invalidating the input operation with respect to a region of the display surface which region corresponds to a result of the determination of the portable device holding hand. Since a drag operation starting from an edge of the display surface reminds a user of dragging of something outside a screen into the screen, the drag operation is frequently assigned to an operation to instruct a new target for selection to be displayed. That is, after the drag operation starting from the edge of the display surface is carried out, an input operation may be carried out with respect to a target for selection which has been newly displayed by the drag operation. Thus, during the input operation, an operational error may be caused in a case where a user erroneously touches a region which the user does not intend to touch. In view of the problem, according to the configuration, the portable device holding hand is determined in accordance with the trajectory of the drag operation starting from the edge of the display surface, and an invalid region corresponding to a result of the determination is set when the determination is carried out. That is, since an invalid region is set at a timing at which an operational error may occur, it is possible to prevent the operational error without causing any trouble to receipt of the input operation.

The portable device according to the foregoing embodiments of the present invention may be realized by a computer. In this case, the present invention encompasses: a control program for the portable device which program causes a computer to operate as the foregoing sections of the portable device so that the portable device can be realized by the computer; and a computer-readable storage medium storing the control program therein. The present invention is not limited to the description of the embodiments above, but may be altered by a skilled person within the scope of the claims. An embodiment based on a proper combination of technical means disclosed in different embodiments is also encompassed in the technical scope of the present invention. Further, a new technical feature can be formed by combining different technical means disclosed in the embodiments.

### INDUSTRIAL APPLICABILITY

The present invention is applicable to portable devices such as a mobile phone and a smartphone.

### REFERENCE SIGNS LIST

1 Portable Device

100 Inclination Sensor (Inclination Detection Section)

122 Menu Display Section (Display Section)

125 Portable Device Holding Hand Determination Section

126 Invalid Region Setting Section (Resetting Section)

1. A portable device for receiving an input operation with respect to a display surface thereof on which to display an image, the portable device comprising:
a display section for, in accordance with a given input operation, displaying, in a partial region of the display surface, an input target object which serves as a target of the input operation;
a portable device holding hand determination section for determining which of a right hand and a left hand is a portable device holding hand; and
an invalid region setting section for, while the input target object is being displayed, invalidating the input operation with respect to a region in which no input target object is displayed and which corresponds to a result of the determination by the portable device holding hand determination section.

2. The portable device as set forth in claim 1, wherein:
the invalid region setting section invalidates the input operation with respect to a region of the display surface which region is located, with respect to the input target object, (i) on a side of a user holding the portable device, and (ii) closer to the portable device holding hand determined by the portable device holding hand determination section.

3. The portable device as set forth in claim 1, wherein:
the given input operation is the input operation which has a given trajectory with respect to the display surface; and
the portable device holding hand determination section determines the portable device holding hand from a trajectory of the input operation that causes the input target object to be displayed.

4. The portable device as set forth in claim 1, wherein:
in a case where a contact with respect to either one of a first expected contact region and a second expected contact region is detected concurrently or sequentially with the input operation with respect to the input target object, the first expected contact region being set, on the display surface in advance, as a region which is highly likely to be touched with a finger of the user while the input operation is being carried out with respect to the input target object with the right hand, the second expected contact region being set, on the display surface in advance, as a region which is highly likely to be touched with the finger of the user while the input operation is being carried out with respect to the input target object with the left hand, the portable device holding hand determination section determines the portable device holding hand in accordance with which of the first and second expected contact regions has been subjected to the contact; and
the invalid region setting section invalidates the input operation with respect to a region including the first or second expected contact region in which the contact has been detected.

5. The portable device as set forth in claim 1, further comprising:
an inclination detection section for measuring an inclination of the portable device,
the portable device holding hand determination section determining the portable device holding hand from the inclination measured by the inclination detection section.

6. The portable device as set forth in claim 1, wherein, in a case where a trajectory of a vertical drag operation with respect to the display surface has an arc shape protruding leftward, the portable device holding hand determination section determines that the portable device is held with the right hand, and in a case where the trajectory of the vertical drag operation with respect to the display surface has an arc shape protruding rightward, the holding hand determination section determines that the portable device is held with the left hand.

7. The portable device as set forth in claim 1, further comprising:
a resetting section for resetting the invalid region in a case where no input operation continues to be detected for a given time after the invalid region is set by the invalid region setting section.

8. A portable device for receiving an input operation with respect to a display surface thereof on which to display an image, the portable device comprising:
a portable device holding hand determination section for determining, from a trajectory of a drag operation starting from an edge of the display surface, which of a right hand and a left hand is a portable device holding hand; and
an invalid region setting section for, when the portable device holding hand determination section determines the portable device holding hand, invalidating the input operation with respect to a region of the display surface which region corresponds to a result of the determination of the portable device holding hand.
